(19) United States
(12) Patent Application Publication
(10) Pub. No.: US 2023/0253676 A1
(43) Pub. Date: Aug. 10, 2023

(54) HYBRID SEPARATING MEMBRANE FOR A BATTERY

(71) Applicant: BLUE SOLUTIONS, ERGUE GABERIC (FR)

(72) Inventors: Margaud LECUYER, COMBRIT (FR); Jonathan SZYMCZAK, QUIMPER (FR); Marc DESCHAMPS, QUIMPER (FR)

(21) Appl. No.: 18/004,316

(22) PCT Filed: Jun. 23, 2021
(86) PCT No.: PCT/EP2021/067077

§ 371 Date: Jan. 5, 2023

(30) Foreign Application Priority Data
Jul. 6, 2020 (FR) FR2007128

(51) Int. Cl. H01M 50/446; H01M 50/44; H01M 50/434; H01M 50/429; H01M 10/0525

(52) U.S. Cl. CPC H01M 50/446; H01M 50/44; H01M 50/434; H01M 50/429; H01M 10/0525

(57) ABSTRACT

A hybrid separating membrane made of a composite material including a non-porous polymer matrix and particles of an ionically conductive inorganic material dispersed in the polymer matrix, to the use of such a membrane as separator in an electrical energy storage system, as well as to a system for storing electrical energy, especially an electrochemical accumulator such as a lithium or sodium secondary battery (rechargeable) comprising at least one such separating membrane.

### FIELD

The present invention relates to the general technical field of electrical energy storage systems.

### BACKGROUND

More particularly, the present invention relates to a hybrid separating membrane consisting of a composite material comprising a non-porous polymer matrix and particles of an ionically conductive inorganic material dispersed in said polymer matrix, to the use of such a membrane by way of separator in an electrical energy storage system, as well as to a system for storing electrical energy, especially an electrochemical accumulator such as a lithium or sodium secondary battery (rechargeable) comprising at least one such separating membrane.

Lithium secondary batteries are generally provided in the form of an assembly of thin films placed on top of one another (roll or stack with the following pattern (electrolyte/cathode/collector/cathode/electrolyte/anode) over n turns) or of n stacked thin films (cut and placed on top of one another, or n stacks of the aforementioned pattern). The electrolyte may be self-supporting or impregnate a porous separator. This stacked/complexed unit pattern has a thickness of the order of one hundred micrometers. Four functional sheets enter into its composition: i) a negative electrode (anode) providing the supply of lithium ions during the discharge of the battery; ii) a choice of either a solid or gelled self-supporting polymer conducting lithium ions, or a porous separator impregnated with an electrolytic solution; iii) a positive electrode (cathode) containing an active electrode material acting as storage of lithium ions; and finally iv) a current collector in contact with the positive electrode and making it possible to ensure the electrical connection.

The negative electrode of lithium metal polymer (LMP®) batteries generally consists of a sheet of pure metallic lithium or of a lithium alloy; the solid or gelled polymer electrolyte generally consists of a polymer based on polyethylene oxide (PEO) and at least one lithium salt; the positive electrode usually consists of a material having a working potential of less than 4 V vs Li⁺/Li (that is the oxidation-reduction potential with respect to lithium is less than 4 V) such as for example a metal oxide (such as for example V₂O₅, LiV₃O₈, LiCoO₂, LiNiO₂, LiMn₂O₄ and LiNi_{0.5}Mn_{0.5}O₂ . . . ) or a LiMPO₄-type phosphate, where M is a metal cation selected from the group Fe, Mn, Co, Ni and Ti, or combinations of these cations, such as for example LiFePO₄, or a conversion material (for example sulfur) and also contains carbon and a polymer; and the current collector generally consists of a metal sheet. Ion conductivity is ensured by the dissolution of the lithium salt in the polymer that is part of the composition of the solid electrolyte.

Sodium-ion (Na-ion) technology appears to be a promising alternative for new generation batteries, in particular in the field of stationary energy storage due to the natural abundance of the sodium element and the low cost thereof with respect to lithium.

Sodium batteries generally have a cathode in which the active material is a compound capable of reversibly inserting sodium ions, an electrolyte comprising a sodium salt that can be easily dissociated, and an anode in which the active material may especially be a pure metal sheet or a sodium-based alloy.

In these two types of batteries, chemical species other than the lithium or sodium cations that ensure the operation of the battery, and such as anions, solvents, polymers, degradation products, etc., can migrate from one side of the electrolyte to the other and come into contact with the electrodes, causing an alteration in the performance of the battery, especially its service life, its capacity and/or its internal resistance. It may also be advantageous to design a battery in which one electrolytic solution is chosen for the operation of the anode while another electrolytic solution is chosen for the operation of the cathode, de facto requiring a physical separation between these two electrolytic solutions.

Several solutions have already been studied in order to protect the electrodes from the migration of chemical species.

It has already been proposed, especially in patent application US 2018/0230610, to protect the surface of the electrodes by a protective ceramic layer. This protection comprises two composite layers, each of the layers consisting of a porous polymer matrix, the pores of which are at least partially filled with a ceramic having ionic conductivity, said ceramic being in contact with the surface of the electrode. Thus, according to this patent application US 2018/0230610, the ceramic is in direct contact with the surface of the electrode, which implies that it is chemically stable with respect to the latter. Furthermore, the polymer constituting the matrix of the composite layer can be permeable to the solvents of the electrolyte and therefore does not prevent the diffusion of the chemical species present in the electrolyte to the thus protected electrode.

Furthermore, the article by Kone (Kelvin) Fu et al. (Energy & Environmental Science, The Royal Society of Chemistry, 2017, DOI:10.1039/c7ee01004d) describes a solid electrolyte for a lithium-sulfur battery, said electrolyte consisting of a first thin, dense ceramic layer and a second thicker porous ceramic layer, the pores of which are filled with a solid electrolyte. This electrolyte has the disadvantage of being rigid and friable. It cannot therefore be integrated into a battery in which the different elements constituting it (electrodes and electrolyte) must be sufficiently flexible to allow them to be rolled up.

There is therefore a need for a technical solution that makes it possible to prevent the migration of the chemical species present in the electrolyte to the electrodes, while allowing the assembly by rolling up the different elements of an electrical energy storage system, in particular a rechargeable battery with lithium or sodium ions.

### SUMMARY

The first subject matter of the present invention is a hybrid separating membrane for an electrical energy storage system, said membrane comprising an organic phase and an inorganic phase, said inorganic phase being dispersed within the organic phase, said membrane being characterized in that:
the organic phase constitutes a non-porous polymer matrix that is impermeable to the electrolyte solvents,
the inorganic phase consists of a set of particles of at least one ionically conductive inorganic material;
the particles of said at least one inorganic material are dispersed in said polymer matrix,
the membrane is provided in the form of a film of thickness e,
the particles of said inorganic material have at least one smallest dimension/and at least one largest dimension L, said dimension L being greater than or equal to the thickness e of the polymer matrix, and
both faces of the membrane are ionically connected to one another either by means of a single particle of inorganic material, or by means of at least two particles of inorganic material in contact with each other.

By virtue of this membrane, it is possible to design rechargeable batteries in which the diffusion of certain chemical species from one electrode to the other is prevented. This membrane thus allows the chemical decoupling of the electrodes by allowing only a transfer of the cationic species necessary for the operation of the battery (lithium or sodium ions). The other chemical species remain blocked on either side of the membrane, thus preserving the good electrochemical performance of the battery over time. Finally, the use of this separating membrane enables the use of very different electrolytic compositions at each electrode, whether for the electrolyte salts, the polymers or the solvents, which makes it possible to adapt the nature of the electrolytes used to the nature of each of the electrodes.

According to the invention:
the expression “non-porous” in relation to the polymer matrix means that said matrix is essentially free of porosity, in other words that its pore volume is less than about 10%;
the expression “impermeable to the electrolyte solvents” in relation to the polymer matrix means that said matrix has a swelling in the presence of said solvents of less than 5% by weight;
the expression “ionic conductor” in relation to the inorganic material means that said inorganic material has an ionic conductivity greater than or equal to about 1.10⁻⁵ S/cm, and preferably greater than or equal to about 3.10⁻⁴ S/cm;
when it is indicated that “both faces of the membrane are ionically connected to one another”, this means that the inorganic phase is conductive, that is that all the particles of said inorganic material that constitute said inorganic phase form a network making it possible to conduct the lithium or sodium cations on either side of said membrane, and especially from one face of said membrane to the other.

According to the invention, the ionic conduction of said membrane is preferably greater than or equal to about 10⁻⁷S/cm, and even more preferentially greater than or equal to about 10⁻⁴ S/cm.

The thickness e of the membrane is preferably less than about 30 μm, and even more preferentially this thickness e is comprised between about 3 and 20 rim, inclusive.

According to a preferred embodiment of the invention, the smallest dimension (I) of the particles of said inorganic material is comprised between about 3 and 15 μm, inclusive, more particularly between about 5 and 8 μm.

According to a preferred embodiment of the invention, the particles of the inorganic material are oriented within the polymer matrix such that the axis passing through their largest dimension L is substantially perpendicular to the thickness of said membrane.

According to the invention, the shape of the particles is no longer critical once they have, as previously indicated, a largest dimension L greater than or equal to the thickness e of the polymer matrix. According to a preferred embodiment of the invention, the particles of said inorganic material may be spherical, parallelepipedal, or else in the form of fibers or rods. According to a particularly preferred embodiment of the invention, the particles of said inorganic material are provided in the form of fibers or rods.

The inorganic material is preferably selected from lithium ion conducting ceramics, lithium ion or sodium ion conducting glasses, and sodium ion conducting ceramics.

Among the lithium ion conducting ceramics, we can cite Li₂ZrSi₆O₁₅ (referred to as LZS), Li₇La₃Zr₂O₁₂ (referred to as LLZO), Li_{1.3}Al_{0.3}Ti_{1.7}(PO₄)₃ (referred to as LATP), LiAlGe₂(PO₄)₃ (referred to as LAGP) ceramics, and LISICON (acronym of “Lithium Super Ionic CONductor”)-type ceramics with chemical formula Li₂₊₂ₓZn₁₋ₓGeO₄; as well as the derivatives thereof, optionally doped. Among such ceramics, the LZS ceramic is particularly preferred.

Among the lithium ion conducting glasses, we can especially cite Li₂SP₂S₅P₂O₅ and its derivatives, Li₃PO₄Li₂SXS₂ with X=Ge, Si . . . and its derivatives, Li, SbS, Li₃BN₂, Li₂OB₂O₃SiO₂, and Li₆PS₅Y (with Y=Cl, Br, I).

Among the sodium ion conducting glasses, we can especially cite Na₃PS₄ and its derivatives Na₃PS₄-NaX (with X=F, Cl, Br, I).

Among the sodium ion conducting ceramics, we can especially cite NASICON (acronym of “sodium (Na) Superlonic Conductor” which can be represented by the chemical formula Na₁₊ₓZr₂SiₓP₃₋ₓO₁₂, 0<x<3.

The membrane preferably contains about 50% to 90% by weight of the ionically conductive inorganic material, about 10% to 50% by weight of a polymer matrix, with respect to the total weight of said membrane.

According to a first embodiment, the non-porous polymer matrix is non-ionically conductive. According to the invention, the expression “non-ionically conductive” in relation to the polymer matrix means that said matrix has an ionic conductivity of less than about 10-7 S/cm, and preferably less than about 10-8 S/cm.

According to this first embodiment, the non-porous polymer matrix contains at least one non-ionically conductive polymer preferably selected from the polyolefins, halogenated polymers, epichlorohydrin homopolymers and copolymers, polyurethanes, styrene homopolymers and copolymers, vinyl polymers, polysaccharides, cellulose derivatives and the mixtures thereof.

Among the polyolefins, we may more particularly cite ethylene and propylene homopolymers or copolymers, as well as the mixtures of at least two of these polymers.

Among the halogenated polymers, we may in particular cite the homopolymers and copolymers of vinyl chloride, vinylidene fluoride (PVdF), vinylidene chloride, ethylene tetrafluoride, or chlorotrifluoroethylene, the copolymers of vinylidene fluoride and hexafluoropropylene (PVdF-co-HFP), and the mixtures thereof.

According to a preferred embodiment of the invention, the polymer(s) of the polymer matrix are selected from polyethylene and the copolymers of vinylidene fluoride and hexafluoropropylene (PVdF-co-HFP).

According to a second embodiment, the non-porous polymer matrix is ionically conductive. In this case, the polymer matrix then further comprises, in addition to the non-ionically conductive polymers listed above, at least one ionically conductive polymer. According to this second variant, the ionically conductive polymer(s) may be selected from the polyethers, polycarbonates, polyamides, polyimides, polypyrroles, and mixtures thereof.

The hybrid separating membrane in accordance with the present invention may also contain one or more salt(s) such as a lithium salt or a sodium salt and/or one or several organic solvent(s).

In this case, the lithium or sodium salt(s) preferably represent about 0.1 to 5% by weight with respect to the total weight of said membrane and the solvent preferably represents about 0.1 to 5% by weight with respect to the total weight of said membrane.

The hybrid separating membrane in accordance with the present invention can be prepared according to the techniques known to a person skilled in the art, and such as, for example, by mixing the different elements that constitute it in a mixer in the presence of an organic solvent in order to obtain a paste which can then be rolled into a film. After rolling, the film is dried.

Such a membrane can then be used as separator in an electrical energy storage system operating by circulation of lithium ions or sodium ions.

A second subject matter of the present invention is therefore the use of a hybrid separating membrane as defined according to the first subject matter of the invention, by way of electrode separator in an electrical energy storage system operating by circulation of lithium or sodium ions and comprising at least one positive electrode, at least one negative electrode, and at least one electrolyte.

According to this use, said membrane is placed between the positive electrode and the negative electrode and makes it possible to electrically isolate said electrodes from each other.

Finally, a third subject matter of the present invention is a system for storing electrical energy operating by circulation of lithium ions or sodium ions, said system comprising at least one positive electrode, at least one negative electrode, and at least one separator provided between said positive and negative electrodes, said system being characterized in that said separator is a hybrid separating membrane as defined according to the first subject matter of the invention.

According to a preferred embodiment of the invention, said storage system comprises at least one positive electrode, at least one negative electrode, at least two electrolytes E1 and E2, and at least one separator provided between said electrolytes E1 and E2.

According to the invention, the energy storage system is preferably a lithium battery.

According to a particular embodiment, said system comprises an assembly of at least one positive electrode, at least one electrolyte film E1, at least one hybrid separating membrane as defined according to the first subject matter of the invention, at least one second electrolyte film E2, and at least one negative electrode, said separating membrane being inserted between the two electrolyte films E1 and E2.

The positive electrode of a lithium battery generally consists of a current collector supporting a composite positive electrode comprising a positive electrode active material, optionally an electronic conducting agent such as carbon, and optionally a polymer binder. The current collector generally consists of a metal sheet, for example an aluminum sheet.

The negative electrode of a lithium battery generally consists of a sheet of metallic lithium or of a lithium alloy.

Electrolytes E1 and E2 may have an identical or different chemical composition one from the other. They may be provided in the form of a solid polymer electrolyte which generally consists of a solid polymer based on polyethylene oxide (PEO) and at least one lithium salt. They may also be in the form of a gelled electrolyte comprising at least one gelling polymer, at least one lithium salt and at least one solvent.

The gelling polymers may be selected from the polyolefins such as the homopolymers or copolymers of ethylene and propylene, or a mixture of at least two of these polymers; the homopolymers and copolymers of ethylene oxide (for example PEO, copolymer of PEO), methylene oxide, propylene oxide, carbonates, epichlorohydrin or allyl glycidyl ether, and mixtures thereof; halogenated polymers such as the homopolymers and copolymers of vinyl chloride, vinylidene fluoride (PVdF), vinylidene chloride, ethylene tetrafluoride, or chlorotrifluoroethylene, the copolymers of vinylidene fluoride and hexafluoropropylene (PVdF-co-HFP), and mixtures thereof; the homopolymers and copolymers of styrene and mixtures thereof; the vinyl polymers; the non-electronically conductive anionic polymers such as poly(styrene sulfonate), poly(acrylic acid), poly(glutamate), alginate, pectin, carrageenan and mixtures thereof; polyacrylates; and one of their mixtures.

The solvent(s) of the gelled electrolyte can be selected from the linear or cyclic ethers, carbonates, sulfurous solvents (sulfolanes, sulfones, DMSO, etc.), the linear or cyclic esters (lactones), the nitriles, etc. . . .

Among such solvents, we may in particular cite dimethyl ether, polyethylene glycol dimethyl ether (or PEGDME) such as tetraethylene glycol dimethyl ether (TEGDME), dioxolane, ethylene carbonate (EC), propylene carbonate (PC), dimethyl carbonate (DMC), diethyl carbonate (DEC), methyl isopropyl carbonate (MiPC), ethyl acetate, ethyl butyrate (EB), and mixtures thereof.

According to a particular and preferred embodiment of the invention, electrolyte E1 has a chemical composition different from the chemical composition of electrolyte E2. Thus, and by way of example, electrolyte E1 between the separator and the positive electrode is an electrolyte based on PVdF, polycarbonate and a lithium salt such as lithium bis(trifluoromethylsulfonyl)imide (LiTFSI) and electrolyte E2 placed between the separator and the negative electrode is based on PEO, PEGDME, and a lithium salt such as LiNO₃.

### BRIEF DESCRIPTION OF THE DRAWINGS

The appended drawings illustrate the invention:

FIG. 1 depicts the evolution of the capacity and the efficiency based on the number of cycles of the battery of example 1 compliant with the invention comprising a non-porous hybrid membrane;

FIG. 2 depicts the evolution of the internal resistance based on the number of cycles of the battery of example 1 compliant with the invention comprising a non-porous hybrid membrane;

FIG. 3 depicts the evolution of the capacity and the efficiency based on the number of cycles of the battery of example 2, non-compliant with the invention, comprising a porous membrane;

FIG. 4 depicts the evolution of the internal resistance based on the number of cycles of the battery of example 2, not in accordance with the invention, comprising a porous membrane;

FIG. 5a and FIG. 5b depict a scanning electron microscopy image of the electrolyte/membrane/electrolyte triple-layer material of example 2, non-compliant with the invention, comprising a porous membrane (5a), as well as a mapping of the chlorine of this same triple-layer material (5b);

FIG. 6 depicts the evolution of the capacity based on the number of cycles of the battery of example 3 in accordance with the invention comprising a dense, non-porous hybrid membrane;

FIG. 7 depicts the evolution of the internal resistance based on the number of cycles of the battery of example 3 compliant with the invention comprising a dense, non-porous hybrid membrane;

FIG. 8 depicts a scanning electron microscopy image of the electrolyte triple-layer material/non-porous hybrid membrane compliant with the invention/electrolyte material of the battery of example 3 compliant with the invention (FIG. 5a), as well as a mapping of the chlorine of this same triple-layer material (FIG. 5b).

### DETAILED DESCRIPTION

### Example 1

### Manufacturing a Non-Porous Separating Membrane Based on poly(vinylidene fluoride-co-hexafluoropropylene) and Ceramic Fibers According to the Invention and Integration in a Lithium Battery

In this example, a non-porous separating membrane was prepared, 30 consisting of a film of a composite material comprising a polymer matrix based on poly(vinylidene fluoride-co-hexafluoropropylene) (PVdF-HFP) and ceramic fibers. The membrane obtained was then integrated as a separator in a lithium battery.

First Step: Preparing the Membrane

30 g of Li₂ZrSi₆O₁₅ ceramic fibers with a diameter predominantly between 3 and 8 μm and a length of about 50 to 500 μm, sold under the reference LZS by the Morgan Advanced Materials, were mixed with 10 g of PVdF-HFP (sold under the trade name Kynar 2751 by Arkema) and 20 g of 99.7% pure propylene carbonate (Sigma Aldrich) in a mixer sold under the trade name Plastograph® EC by Brabender at a temperature of 70° C. The resulting paste was then rolled between two films of siliconized polyethylene at 130° C. in order to obtain films with a thickness of about 30 μm. These films were then dried at 25° C. for 24 hours under a flushing of anhydrous air (dew point −40° C.).

Second Step: Preparing the Solid Polymer Electrolyte Films

Solid polymer electrolyte films were prepared by mixing 40 g of polyethylene oxide sold under the reference PEO 1 L by Sumitomo Seika and 10 g of lithium bis(trifluoromethylsulfonyl)imide (LiTFSI—Solvay) in the Plastograph® EC mixer at a temperature of 80° C. The paste thus obtained was rolled between two films of siliconized polyethylene at 80° C. in order to obtain films with a thickness of about 10 μm.

Third Step: Preparing a Composite Positive Electrode Film

A composite positive electrode film was prepared by mixing 74% by weight of LiFePO₄ (Sumimoto Osaka Cement), 19% by weight of PEO 1 L, 5% by weight of LiTFSI, and 2% by weight of carbon black sold under the trade name Ketjenblack EC600JD (Akzo Nobel) in the Plastograph® EC mixer at a temperature of 80° C. The resulting paste was rolled on an aluminum current collector (3M).

Fourth Step: Assembling the Battery

The films obtained in the first step hereinbefore were used within a lithium battery. The battery was assembled in a dry room (dew point −40° C.).

A film of the material obtained in the first step hereinbefore was complexed by rolling between two polymer electrolyte films as prepared in the second step hereinbefore, at a temperature of 80° C. and under 0.5 MPa (5 bar) of pressure. The assembly thus obtained was then inserted between the composite positive electrode film obtained in the third step hereinbefore and a negative electrode of metallic lithium by rolling, still at a temperature of 80° C. under 0.5 MPa, in cells of small size, of the “pouch cell” type of about 15 mAh and having a surface area of about 10 cm².

The cells thus obtained were cycled at 80° C. in galvanostatic cycling (C/10+1.5 h of potentiostatic hold at 3.6 V; D/10 between 2.5 and 3.6 V).

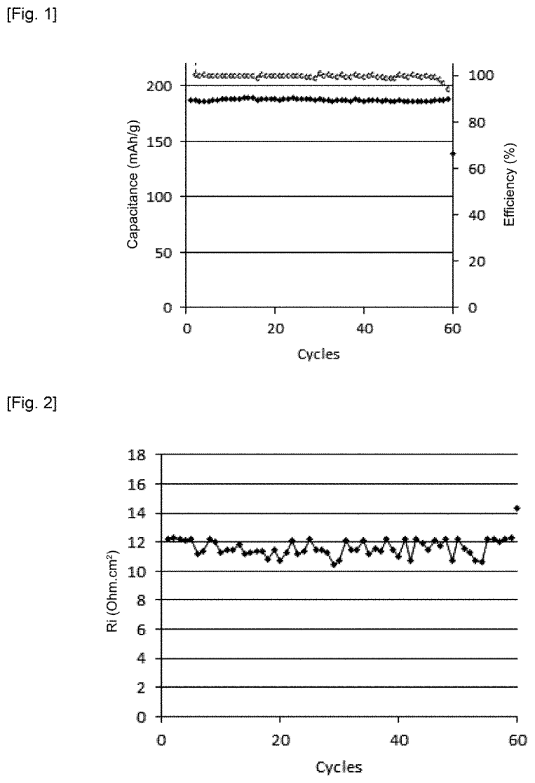

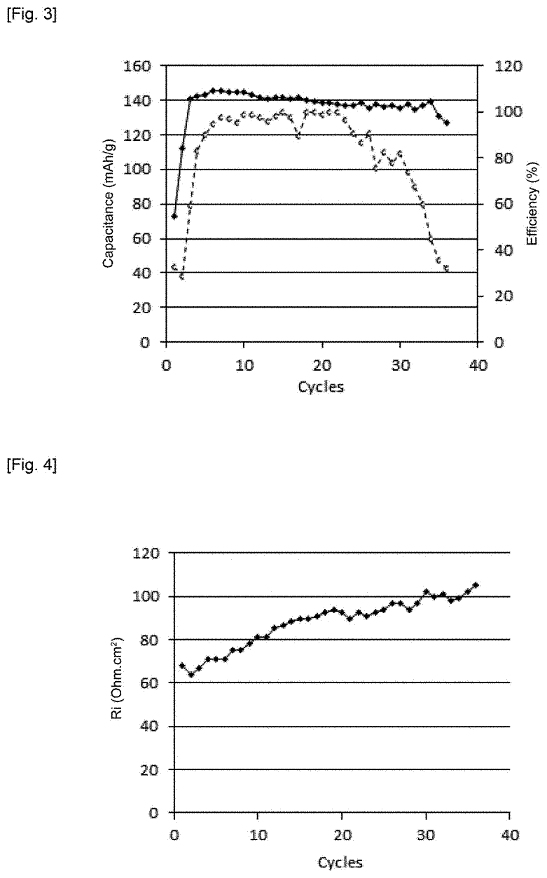

The results obtained are given in the appended FIGS. 1 and 2.

FIG. 1 shows the evolution of the capacity (full diamonds) and the efficiency (empty diamonds) of the battery based on the number of cycles.

FIG. 2 shows the evolution of the internal resistance of the battery of example 1 compliant with the invention based on the number of cycles.

These results show that the performance of the battery is stable when over at least 60 cycles, confirming the good conductivity and good interfaces of the system, allowing for correct operation of the battery.

### Example 2

### Manufacturing a Porous Separating Membrane Based on poly(vinylidene fluoride-co-hexafluoropropylene) and Ceramic Fibers Noncompliant with the Invention and Iintegration in a Lithium Battery

In this example, a porous separating membrane non-compliant with the present invention was prepared, said membrane consisting of a film of a porous composite material comprising a polymer matrix based on polyvinylidene fluoride (PVdF) and ceramic fibers. The porous membrane not non-compliant with the invention thus obtained was then integrated as separator in a lithium battery.

First Step: Preparing the Porous Membrane

24 g of LZS ceramic fibers sold by Morgan Advanced Materials were mixed, under magnetic stirring at 24° C., with 8 g of PVdF (sold under the reference 5130 by Solvay) and 20 g of 99% pure acetonitrile (Sigma Aldrich). The resulting paste was then spread onto a backing film made of polypropylene and then dried in dry air. These films were then dried at 25° C. for 24 hours under a flushing of anhydrous air (dew point −40° C.).

Second Step: Preparing a Gelled Electrolyte Based on Dimethyl Glycol Dimethyl Ether

A first gelled electrolyte film was prepared by mixing 35 g of polyethylene oxide sold under the reference POE 1 L by Sumitomo Seika, 18 g of polyethylene glycol dimethyl ether (PEGDME) at 240 g/mol (TCI Chemicals) and 17 g of LiClO₄ 4H₂O (Sigma Aldrich) in the Plastograph® EC mixer at a temperature of 80° C. The resulting paste was rolled between two films of siliconized polyethylene at 80° C. in order to obtain films with a thickness of about 10 μm.

Third Step: Preparing a Gelled Electrolyte Based on Ethylene Carbonate

A second gelled electrolyte film was prepared by mixing 4 g of PVdF 5130 (Solvay), 2.6 g of 1.2 M LiTFSI solution (Solvay) in ethylene carbonate (Sigma Aldrich), and 30 g of pure acetonitrile (Sigma Aldrich).

The mixture was spread onto a polypropylene backing film. The acetonitrile was evaporated in the open air in a dry room (dew point −40° C.) for 24 h before use.

Fourth Step: Preparing a Composite Positive Electrode Film

A composite positive electrode film was prepared by mixing 71% by weight of LiNi_{0.6}Mn_{0.2}Co_{0.2}O₂ (also referred to as NMC; Umicore), 5% by weight of PVdF-HFP (Solef® 21510 Solvay), 16% by weight of an equivolume mixture of ethylene carbonate and propylene carbonate, 6% by weight of LiTFSI and 2% by weight of carbon black sold under the trade name Ketjenblack EC600JS (Akzo Nobel) in the Plastograph® EC mixer at a temperature of 135° C. The resulting paste was rolled on an aluminum current collector (3M).

Fifth Step: Assembling the Battery

The porous membrane obtained in the first step hereinbefore was then complexed by rolling between the first and the second gelled electrolytes as obtained in the second and third steps hereinbefore, respectively, at 80° C., under 0.5 MPa of pressure. The “triple-layer” assembly thus obtained was then inserted between a composite positive electrode film as obtained in the fourth step hereinbefore and a negative electrode of metallic lithium by rolling, still at a temperature of 80° C. under 0.5 MPa, in cells of small size, of the “pouch cell” type, of about 15 mAh and having a surface area of about 15 cm2. The battery was assembled in a dry room (dew point −40° C.).

The cell thus obtained was cycled at 40° C. in galvanostatic cycling (C/10+potentiostatic hold at 4.25 V for 1.5 h; D/10, then C/10+potentiostatic hold at 4.25 V for 1.5 h; D/5 between 3 and 4.25 V).

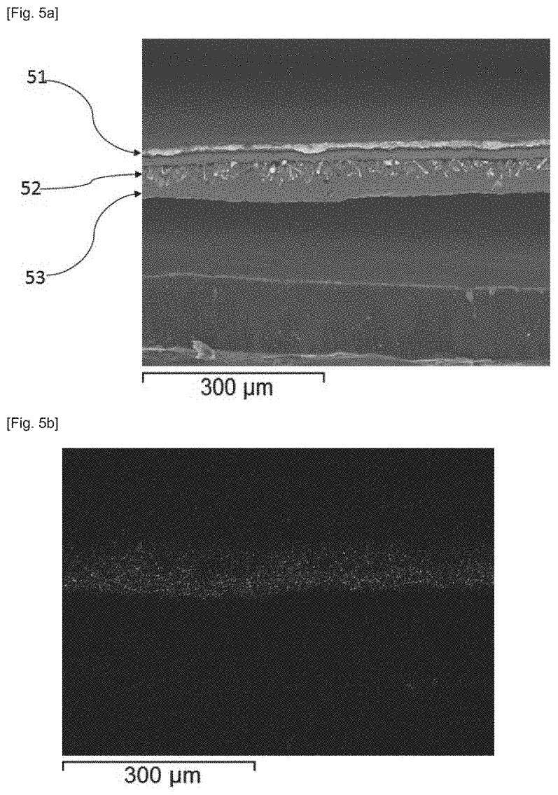

The results obtained are given in appended FIGS. 3 and 4.

FIG. 3 shows the evolution of the capacity (full diamonds) and the efficiency (empty diamonds) of the battery based on the number of cycles.

FIG. 4 shows the evolution of the internal resistance of the battery based on the number of cycles.

The results presented in appended FIGS. 3 and 4 show that the porous membrane non-compliant with the invention has insufficient performance when cycling: it does not provide a barrier against the solvents of the electrolytes, which causes these electrolytes to mix and leads to a degradation of the two electrodes. This results in an increase in the internal resistance of the battery (FIG. 4). Its incorrect operation leads to a drop in efficiency, which causes premature end of life.

Furthermore, the “triple layer” made up of the assembly of the non-porous membrane and the first and second gelled electrolytes was stored for 5 days at 40° C. and then analyzed by scanning electron microscopy associated with a microanalysis by energy-dispersive X-ray (SEM/EDX Hitachi TM3000) on the edge of the assembly. The mapping of the element chlorine in the triple layer was analyzed since it is indicative of the permeability of the separating membrane, as the element chlorine can only come from the lithium salt used in the PEGDME-based electrolyte, namely LiClO₄.

The results are shown in appended FIG. 5. FIG. 5a is an SEM image of the triple layer in cross-section. FIG. 5a shows a layer of the film of the second gelled electrolyte based on ethylene carbonate 51, a layer of porous separating membrane 52, and a layer of the film of the first gelled electrolyte based on polyethylene glycol dimethyl ether 53. FIG. 5b depicts the mapping of the chlorine.

The results presented in FIG. 5 show that after 5 days of storage at 40° C., the chlorine is detected throughout the assembly of the triple layer, whereas it was initially present only in the layer of the film of the first gelled electrolyte based on polyethylene glycol dimethyl ether 53 (not shown). The chlorine content was assessed as being 4% by weight in each of the layers 51 and 53 of gelled electrolyte. This shows that the porous membrane non-compliant with the present invention is capable of preventing the mixing of the two electrolyte solvents and thus the migration of chloride ions.

### Example 3

### Manufacturing a Dense, Non-Porous Separating Membrane Based on Polyethylene Oxide and Ceramic Fibers Compliant with the Invention and Integration in a Lithium Battery

In this example, a dense, non-porous separating membrane compliant with the invention was prepared, consisting of a film of a composite material comprising a polymer matrix comprising a plastomer based on ethylene, polyethylene oxide (PEO) and ceramic fibers. The membrane obtained was then integrated as a separator in a lithium battery.

First Step: Preparing the Membrane

60 g of LZS ceramic fibers sold by Morgan Advanced Materials were mixed with 14.8 g of a plastomer (CAS-No. 26221-73-8, sold under the trade name Quéo® 0201 by Borealis), 2.2 g of polyethylene oxide sold under the trade name ICPSEB (Nippon ShokubaI), and 0.7 g of LiTFSI (Solvay) in a mixer sold under the trade name Plastograph® EC by Brabender at a temperature of 150° C. The resulting paste was then rolled between two films of siliconized polyethylene at 130° C. in order to obtain films with a thickness of about 22 μm. These films were then dried at 25° C. for 24 hours under a flushing of anhydrous air (dew point −40° C.).

Second Step: Preparing a Gelled Electrolyte Based on Diethylene Glycol Dimethyl Ether

A first gelled electrolyte film was prepared by mixing 72 g of a copolymer of polyethylene oxide and polypropylene oxide sold under the trade name Alkox EP10 by Meisei, 8 g of a 3M LiNO3 solution (Alfa Aesar) in polyethylene glycol dimethyl ether (PEGDME) at 240 g/mol (TCI Chemicals) in the Plastograph® EC mixer at a temperature of 80° C.

The mixture thus obtained is rolled between two films of siliconized polyethylene at 60° C. in order to obtain films with a thickness of about 10 μm.

Third Step: Preparing a Gelled Electrolyte Based on Ethylene Carbonate

A second gelled electrolyte film was prepared by mixing 4 g of PVdF 5130 (Solvay), 2.6 g of 1.2 M LiTFSI solution (Solvay) in ethylene carbonate (Sigma Aldrich), and 30 g of pure acetonitrile (Sigma Aldrich).

The mixture was spread onto a polypropylene backing film. The acetonitrile was evaporated in the open air in a dry room (dew point −40° C.) for 24 h before use.

Fourth Step: Preparing a Composite Positive Electrode Film

A composite positive electrode film was prepared by mixing 71% by weight of LiNi_{0.6}Mn_{0.2}Co_{0.2}O₂ (also referred to as NMC; Umicore), 5% by weight

of PVdF-HFP (Solef® 21510 Solvay), 16% by weight of an equivolume mixture of ethylene carbonate and propylene carbonate, 6% by weight of LiTFSI and 2% by weight of carbon black sold under the trade name Ketjenblack EC600JS (Akzo Nobel) in the Plastograph® EC mixer at a temperature of 135° C. The resulting paste was rolled on an aluminum current collector (3M).

Fifth Step: Assembling the Battery

The dense, non-porous membrane obtained in the first step hereinbefore was then complexed by rolling between the first and the second gelled electrolytes as obtained in the second and third steps hereinbefore, respectively, at 80° C., under 0.5 MPa of pressure. The “triple-layer” assembly thus obtained was then inserted between a composite positive electrode film as obtained in the fourth step hereinbefore and a negative electrode of metallic lithium by rolling, still at a temperature of 80° C. under 0.5 MPa, in cells of small size, of the “pouch cell” type of about 15 mAh and having a surface area of about 15 cm2. The battery was assembled in a dry room (dew point −40° C.).

The cell thus obtained was cycled at 40° C. in galvanostatic cycling (C/10+floating 1.5 h; D/10, then C/10+floating 1.5 h; D/5 between 3 and 4.25 V).

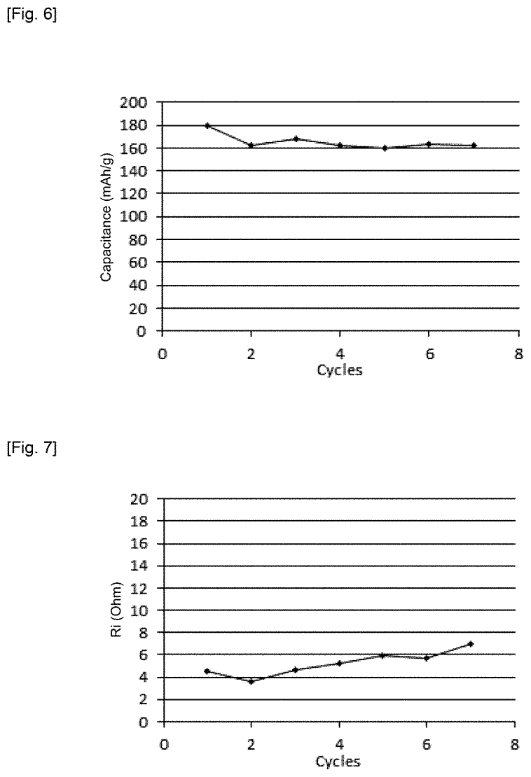

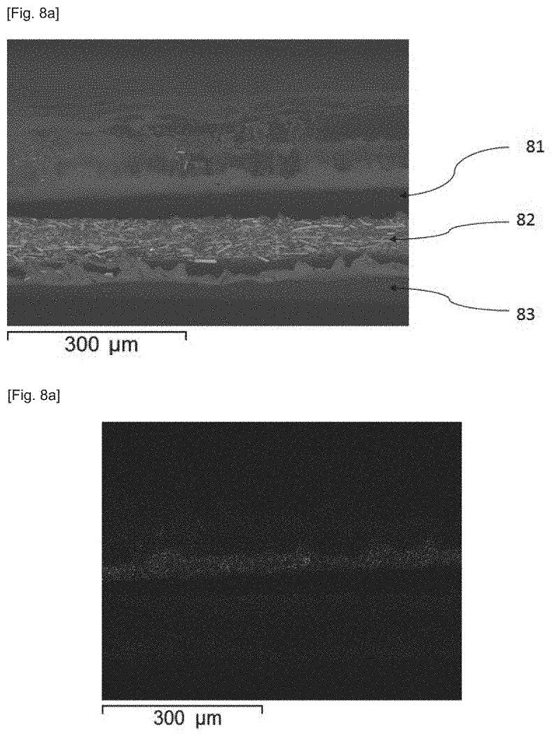

The results obtained are given in appended FIGS. 6 and 7.

FIG. 6 shows the evolution of the capacity of the battery based on the number of cycles.

FIG. 7 shows the evolution of the internal resistance of the battery based on the number of cycles.

These results show that the performance of the battery integrating the dense, non-porous membrane compliant with the invention is stable when cycling.

Moreover, its ability to prevent the mixing of the solvents present in the gelled electrolytes was also tested according to the protocol indicated above in example 2, on a triple layer comprising:
a film of a first gelled electrolyte based on polyethylene glycol dimethyl ether and 2.5 M LiClO₄,
the dense, non-porous membrane as prepared in step 1 hereinbefore,
a film of a second gelled electrolyte based on ethylene carbonate and LiTFSI.

The results obtained are given in appended FIG. 8. FIG. 8a is a SEM image of the triple layer in cross-section. FIG. 8a shows a gelled electrolyte layer based on polyethylene glycol dimethyl ether and LiClO₄ 81, a dense, non-porous separating membrane layer 82 compliant with the invention and a gelled electrolyte layer based on ethylene carbonate and LiTFSI 83. FIG. 8b depicts the mapping of the chlorine.

The results presented in FIG. 8 show that after 5 days of storage at 40° C., the chlorine is barely detected in the gelled electrolyte layer based on dimethyl carbonate and LiTFSI 81 (1% by weight versus 12% in the electrolyte). This demonstrates that the dense, non-porous membrane compliant with the present invention is capable of preventing the diffusion of the two electrolyte solvents and thus the migration of chloride ions.

1-16. (canceled)

17. A hybrid separating membrane for an electrical energy storage system, said membrane comprising an organic phase and an inorganic phase, said inorganic phase being dispersed within the organic phase, wherein:
the organic phase is a non-porous polymer matrix that is impermeable to the electrolyte solvents,
the inorganic phase consists of a set of particles of at least one ionically conductive inorganic material;
the particles of said at least one inorganic material are dispersed in said polymer matrix,
the polymer matrix is provided in the form of a film having a thickness,
the particles of said inorganic material have at least one smallest dimension and at least one largest dimension, said at least one largest dimension being greater than or equal to the thickness of the polymer matrix, and
the two faces of the membrane are ionically connected to one another either by means of a single particle of inorganic material, or by means of at least two particles of inorganic material in contact with each other.

18. The membrane according to claim 17, wherein the thickness of said membrane is between 3 and 20 μm, inclusive.

19. The membrane according to claim 17, wherein the at least one smallest dimension of the particles of said inorganic material is between 3 and 15 μm, inclusive.

20. The membrane according to claim 17, wherein the particles of the inorganic material are oriented within the polymer matrix such that the axis passing through their at least one largest dimension is substantially perpendicular to the thickness of said membrane.

21. The membrane according to claim 17, wherein the inorganic material is selected from lithium ion conducting ceramics, lithium ion or sodium ion conducting glasses, and sodium ion conducting ceramics.

22. The membrane according to claim 21, wherein the lithium ion conducting ceramics are selected from the group consisting of Li₂ZrSi₆O₁₅, Li₇La₃Zr₂O₁₂, ₇(PO₄)₃, LiAlGe₂(PO₄)₃ ceramics, and the ceramics with chemical formula Li₂₊₂ₓZn₁₋ₓGeO₄ and derivatives thereof.

23. The membrane according to claim 17, wherein the particles of said inorganic material are provided in the form of fibers or rods.

24. The membrane according to claim 17, wherein the non-porous polymer matrix is non-ionically conductive and in that it contains at least one non-ionically conductive polymer preferably selected from the polyolefins, halogenated polymers, epichlorohydrin homopolymers and copolymers, polyurethanes, styrene homopolymers and copolymers, vinyl polymers, polysaccharides, cellulose derivatives and mixtures thereof.

25. The membrane according to claim 17, wherein the non-porous polymer matrix is ionically conductive and in that the polymer matrix comprises at least one ionically conductive polymer.

26. The membrane according to claim 17, wherein the membrane contains one or more salt(s) such as a lithium salt or a sodium salt and/or one or several organic solvent(s).

27. A method of assembling an electrical energy storage system operating by circulation of lithium or sodium ions, comprising combining the hybrid separating membrane as defined in claim 17 as an electrode separator with at least one positive electrode, at least one negative electrode, and at least one electrolyte.

28. An electrical energy storage system operating by circulation of lithium ions or sodium ions, said system comprising at least one positive electrode, at least one negative electrode, and at least one separator provided between said electrodes, wherein said separator is a hybrid separating membrane as defined in claim 17.

29. The electrical energy storage system according to claim 28, wherein said system comprises at least one positive electrode, at least one negative electrode, at least two electrolytes, and at least one separator provided between said electrolytes, said at least one separator being said hybrid separating membrane.

30. The electrical energy storage system according to claim 28, wherein said system is a lithium battery.

31. The electrical energy storage system according to claim 29, wherein said system comprises an assembly of at least one positive electrode, at least one electrolyte film, at least one hybrid separating membrane, at least one second electrolyte film, and at least one negative electrode, said separating membrane being inserted between the two electrolyte films.

32. The electrical energy storage system according to claim 29, wherein a first electrolyte of the at least two electrolytes has a chemical composition different from a chemical composition of a second electrolyte of the at least two electrolytes.
